(19) United States
(12) Patent Application Publication
(10) Pub. No.: US 2024/0020622 A1
(43) Pub. Date: Jan. 18, 2024

(54) METHODS AND SYSTEMS FOR LINKING ACCOUNTS ACROSS DISPARATE COMPUTING SYSTEMS TO FACILITATE INFORMATION RETRIEVAL

(71) Applicant: Shopify Inc., Ottawa (CA)

(72) Inventors: Elad TCHETCHIK, Toronto (CA); Kenneth COHEN, Tulsa, OK (US)

(21) Appl. No.: 17/864,162

(22) Filed: Jul. 13, 2022

(51) Int. Cl. G06Q 10/08

(52) U.S. Cl. CPC G06Q 10/0833

(57) ABSTRACT

Methods and systems for linking accounts across disparate computing systems to facilitate information retrieval are described. In an example, an input string is received from a user device associated with a user account. The input string is determined to correspond to a known identifier format and a list of one or more known identifiers associated with the user account does not include an identifier matching the input string. In response, a prompt is generated, for output by the user device, to link a third-party account with the user account.

### FIELD

The present disclosure is related to access control and authorization, and more particularly to linking of accounts associated with different computer systems, and yet more particularly to linking accounts across computer systems based on identifiers to facilitate automatically obtaining information from a linked account.

### BACKGROUND

In order to accomplish different computing tasks in a networked environment, information may need to be retrieved from disparate computing systems. In some cases, users may have different accounts with each or various of such disparate systems.

For example, a user may wish to get tracking information about different packages the user is sending or receiving. However, different packages may be carried by different service providers, each of which may operate its own computing system for tracking packages they are handling. Obtaining information from different accounts across such disparate computing systems may require identification of corresponding user accounts, managing lists of such accounts, and managing associated credentials and access information.

### SUMMARY

A user may have user accounts with different service providers, each of which may operate its own computing system. Generally, accessing different accounts on different computing systems require different credentials or access data, and information from an account on one computing system cannot be accessed by another computing system. In the case where the different service providers provide package delivery or package tracking/monitoring services, this means that tracking information from accounts across different service providers cannot be readily accessed without the user providing the appropriate credentials to each computing system.

A user may have an account on a software platform (which may be a software as a service (SaaS) platform, such as a cloud-computing platform or an e-commerce platform). The software platform may provide a service to the user to enable the user to track packages being carried and/or monitored by third-party service providers. Thus, the software platform may provide a convenient single page where the user can view tracking information from different third-party service providers, without requiring the user to navigate to different webpages of different service providers.

If the user has an account with a third-party service provider, the user's third-party account may be linked with the user's account on the software platform. Linking the user's account on the software platform with the user's third-party account may involve, for example, obtaining and storing at the software platform a piece of access data (e.g., digital token, encrypted key, etc.) that can be used by the software platform to extract tracking information from the third-party account, without requiring the user to provide explicit login each time. In this way, the software platform may automatically extract tracking information from different third-party accounts (maintained by different third-party service providers) and provide the extracted tracking information to the user in single page or summary. However, the ability of the software platform to provide tracking information from different third-party service providers is dependent on having the appropriate access data or credential that links the user's account on the software platform with the user's third-party accounts with the third-party service providers. The retrieval of information from across the disparate computing systems of different third-party service providers is thus hampered by the problem that different accounts require different access data (e.g., username, digital token, encrypted key, etc.) to enable access.

Further, the user may not know which third-party service provider to link up to the software platform (e.g., if the user is the recipient of a package and does not know the carrier being used to deliver the package) and/or the user may find it cumbersome to provide multiple inputs to create the link (e.g., the user may find it cumbersome or tedious to locate and select the appropriate service provider from a long list of possible service providers) such as if the user is providing inputs via a device having limited screen size (e.g., a smartphone or other handheld device). The result is that the software platform is not able to access data from the user's third-party account and cannot automatically extract tracking information for the user.

In various examples, the present disclosure describes systems and methods that enable a software platform to automatically determine that an input string (e.g., inputted as a search query by a user) corresponds to a known package tracking identifier format. The user is then automatically prompted to link a third-party account with the user account on the software platform. The third-party account may then be linked so that the software platform can automatically extract tracking information from the linked third-party account and present the extracted tracking information to the user (e.g., as a returned search result). This provides a technical advantage in that the user interface and user interactions can be simplified, particularly in the case where the user is interacting with the software platform via a device with limited input mechanisms and/or limited screen size (e.g., a smartphone).

In some examples, the present disclosure describes a computer-implemented method including: receiving, from a user device associated with a user account, an input string; determining that the input string corresponds to one or more known identifier formats and that a list of one or more known identifiers associated with the user account does not include an identifier matching the input string; and responsive to determining that the list of one or more known identifiers associated with the user account does not include an identifier matching the input string, generating a prompt, for output by the user device, to link a third-party account with the user account.

In some examples, the one or more known identifier formats may be known package tracking identifier formats, and the user account may not include a package tracking identifier matching the input string.

In some examples, the method may further include: identifying a third-party service provider based on the input string; wherein the generated prompt is to link a third-party account associated with the identified third-party service provider.

In some examples, the identified third-party service provider may be identified based on the input string corresponding to a particular known package tracking identifier format associated with the identified third-party service provider.

In some examples, the method may further include: responsive to receiving, from the user device, an indication of authorization to link a particular third-party account with the user account, obtaining and storing access data for linking the particular third-party account with the user account.

In some examples, the method may further include: updating the list of one or more tracked package identifiers associated with the user account to include a particular package tracking identifier corresponding to the input string; and outputting, via the user device, package tracking information associated with the particular package tracking identifier, the package tracking information being obtained from the linked particular third-party account.

In some examples, the package tracking information may be obtained from the linked particular third-party account by providing the particular package tracking identifier as a query to a third-party service provider associated with the particular third-party account.

In some examples, the method may further include: receiving, from the user device, a further input string; determining that the further input string corresponds to a particular known package tracking identifier format associated with the linked particular third-party account and that the list of one or more tracked package identifiers associated with the user account does not include a package tracking identifier matching the further input string. The method may further include, absent further communication with the user device: obtaining, from the linked particular third-party account, further package tracking information associated with a further package tracking identifier corresponding to the further input string; updating the list of one or more tracked package identifiers associated with the user account to include the further package tracking identifier; and outputting, via the user device, the further package tracking information.

In some examples, the method may further include, absent further communication with the user device: extracting, from the linked particular third-party account, a new package tracking identifier, the new package tracking identifier being absent from the list of one or more tracked package identifiers associated with the user account; and updating the list of one or more tracked package identifiers associated with the user account to include the new package tracking identifier.

In some examples, the method may further include: responsive to receiving, from the user device, a new input string corresponding to the new package tracking identifier, outputting, via the user device, new package tracking information associated with the new package tracking identifier, the new package tracking information being obtained from the linked particular third-party account.

In some examples, the method may further include: identifying a third-party service provider that is not associated with any third-party account currently linked with the user account; wherein the generated prompt is to link a third-party account associated with the identified third-party service provider.

In some examples, the present disclosure describes a computing system including a processor configured to execute instructions to cause the system to: receive, from a user device associated with a user account, an input string; determine that the input string corresponds to one or more known package tracking identifier formats and that a list of one or more tracked package identifiers associated with the user account does not include a package tracking identifier matching the input string; and responsive to determining that the list of one or more tracked package identifiers associated with the user account does not include a package tracking identifier matching the input string, generate a prompt, for output by the user device, to link a third-party account with the user account.

In some examples, the processor may be further configured to execute the instructions to cause the system to: identify a third-party service provider based on the input string; wherein the generated prompt is to link a third-party account associated with the identified third-party service provider.

In some examples, the identified third-party service provider may be identified based on the input string corresponding to a particular known package tracking identifier format associated with the identified third-party service provider.

In some examples, the processor may be further configured to execute the instructions to cause the system to: responsive to receiving, from the user device, an indication of authorization to link a particular third-party account with the user account, obtain and store access data for linking the particular third-party account with the user account.

In some examples, the processor may be further configured to execute the instructions to cause the system to: update the list of one or more tracked package identifiers associated with the user account to include a particular package tracking identifier corresponding to the input string; and output, via the user device, package tracking information associated with the particular package tracking identifier, the package tracking information being obtained from the linked particular third-party account.

In some examples, the processor may be further configured to execute the instructions to cause the system to: receive, from the user device, a further input string; determine that the further input string corresponds to a particular known package tracking identifier format associated with the linked particular third-party account and that the list of one or more tracked package identifiers associated with the user account does not include a package tracking identifier matching the further input string; absent further communication with the user device: obtain, from the linked particular third-party account, further package tracking information associated with a further package tracking identifier corresponding to the further input string; update the list of one or more tracked package identifiers associated with the user account to include the further package tracking identifier; and output, via the user device, the further package tracking information.

In some examples, the processor may be further configured to execute the instructions to cause the system to, absent further communication with the user device: extract, from the linked particular third-party account, a new package tracking identifier, the new package tracking identifier being absent from the list of one or more tracked package identifiers associated with the user account; and update the list of one or more tracked package identifiers associated with the user account to include the new package tracking identifier.

In some examples, the processor may be further configured to execute the instructions to cause the system to: responsive to receiving, from the user device, a new input string corresponding to the new package tracking identifier, output, via the user device, new package tracking information associated with the new package tracking identifier, the new package tracking information being obtained from the linked particular third-party account.

In some examples, the processor may be further configured to execute the instructions to cause the system to: identify a third-party service provider that is not associated with any third-party account currently linked with the user account; wherein the generated prompt is to link a third-party account associated with the identified third-party service provider.

In some examples, the present disclosure describes a computer-readable medium storing instructions that, when executed by a processor of a computing system, cause the computing system to: receive, from a user device associated with a user account, an input string; determine that the input string corresponds to one or more known package tracking identifier formats and that a list of one or more tracked package identifiers associated with the user account does not include a package tracking identifier matching the input string; and responsive to determining that the list of one or more tracked package identifiers associated with the user account does not include a package tracking identifier matching the input string, generate a prompt, for output by the user device, to link a third-party account with the user account.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1 is a block diagram illustrating an example software platform, in accordance with examples of the present disclosure;

FIG. 2 is a block diagram of an example computing system, which may be used to implement examples of the present disclosure;

FIG. 3A is a flowchart illustrating an example method for generating a prompt to link a third-party account, in accordance with examples of the present disclosure;

FIG. 3B is a flowchart illustrating an example method for obtaining package tracking information, in accordance with examples of the present disclosure;

FIGS. 4A-4D illustrate example user interfaces, in accordance with examples of the present disclosure;

FIG. 5 is a block diagram of an example e-commerce platform and a customer device, which may be an example implementation of the software platform of FIG. 1;

FIG. 6 is an example homepage of an administrator, which may be accessed via the e-commerce platform of FIG. 5; and

FIG. 7 is another block diagram of the example e-commerce platform of FIG. 5 including a package tracking engine, in accordance with examples of the present disclosure.

Similar reference numerals may have been used in different figures to denote similar components.

### DETAILED DESCRIPTION

To assist in understanding the present disclosure, an example software platform is first described. The software platform may provide, for example, cloud-based services, software as a service (SaaS), platform as a service (PaaS), desktop as a service (DaaS), managed software as a service (MSaaS), mobile backend as a service (MBaaS), information technology management as a service (ITMaaS), etc. In some examples, the software platform may be or may include an online search platform, an e-commerce platform, a software development platform, etc.

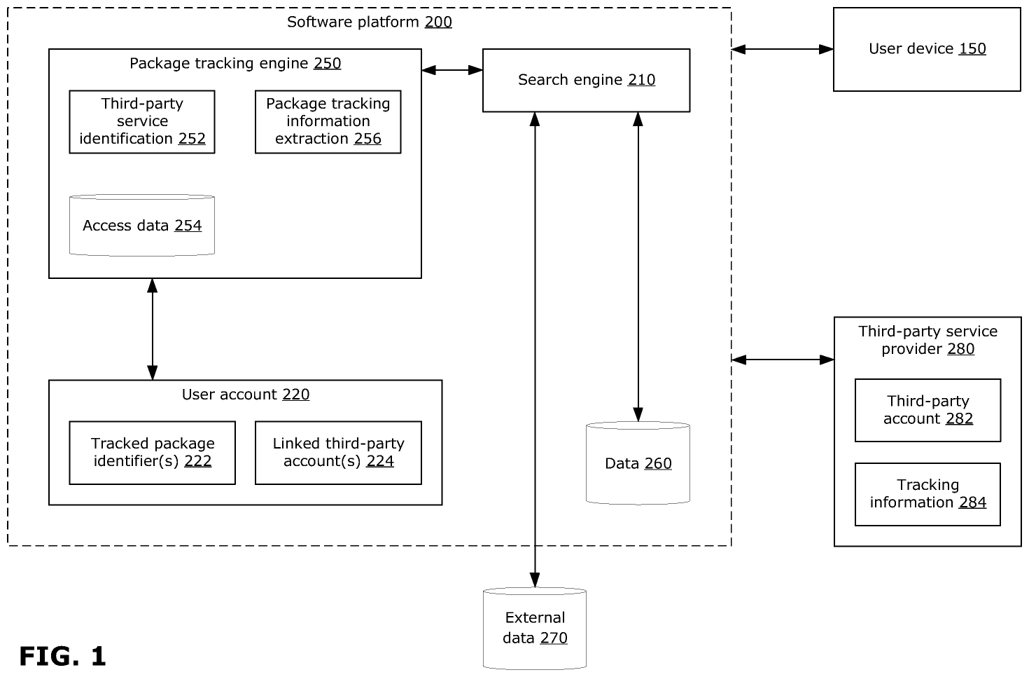

FIG. 1 illustrates an example software platform 200, in accordance with some examples of the present disclosure.

In the example shown, the software platform 200 includes a search engine 210 and a package tracking engine 250 that provide services (e.g., an online search service and a package tracking service, respectively) that are accessible to a user via a user device 150 (e.g., a desktop computer, a smartphone, a tablet device, a laptop device or any other end user device).

The user may be associated with a user account 220 maintained on the software platform 200. For example, the user may, via the user device 150, log onto the software platform 200 by inputting a username and password associated with the user account 220. In some examples, the user device 150 may be registered with the software platform 200, and the user may not need to explicitly provide a username and password each time the user interacts with the software platform 200 via the user device 150. The user account 220 may store information associated with the user, such as a user profile (not shown), a list of tracked package identifier(s) 222 and/or a list of linked third-party account(s) 224.

For example, the user may use the search engine 210 to carry out an online search. An input string may be received as a search query from the user device 150. The search engine 210 may process the input string and retrieve search results from data 260 internal to the software platform 200 and/or from external data 270 (e.g., data maintained by a database or other server external to the software platform 200). The search results may then be returned to the user device 150.

In another example, the user may use the package tracking engine 250 to view tracking information for one or more tracked packages. In particular, the package tracking engine 250 enables tracking information for tracked packages carried and/or monitored by a third-party service provider 280 (e.g., a carrier that is not part of the software platform 200 and/or is not administrated by the software platform 200) to be viewable via a page (e.g., a homepage or search page) provided by the software platform 200, without requiring the user to navigate to the third-party service provider 280.

Details of the functionalities provided by the package tracking engine 250 will be described in greater detail below. Some example components of the package tracking engine 250 are now described. In the example of FIG. 1, the package tracking engine 250 may include a third-party service identification module 252, which may perform operations to enable identification of a third-party service provider, for example based on the input string from the user device 150 matching a package tracking identifier format that is used by a particular third-party service provider. The package tracking engine 250 may also include an access data store 254 storing access data (e.g., access tokens, digital certificates, digital keys, etc.), which may be used to access a third-party account 282 maintained by the third-party service provider 280. In particular, the access data may be used to access a particular third-party account 282 that is linked to a particular user account 220 on the software platform 200. The package tracking engine 250 may also include a package tracking information extraction module 256, which may perform operations to extract, from the third-party service provider 280, tracking information 284 associated with a linked third-party account 282. In particular, the package tracking information extraction module 256 may extract tracking information 284 for one or more tracked packages included in a list of tracked package identifier(s) 222 associated with the user account 220. The package tracking information extraction module 256 may also extract new package tracking identifiers from linked third-party accounts 282 and may automatically add the new package tracking identifiers to the list of tracked package identifier(s) 222. Package tracking identifiers in the list of tracked package identifier(s) 222 may be listed with their corresponding linked third-party account 282 and/or the last known tracking information (e.g., shipping status such as shipped, in transit, at customs, delivered, etc.) of the corresponding package. In some examples, a package tracking identifier in the list of tracked package identifier(s) 222 may further be stored with information about the package corresponding to the package tracking identifier, such as the contents of the package, the shipper, the intended recipient, the third-party service provider used, the price of the shipping, the price of the package contents, etc.

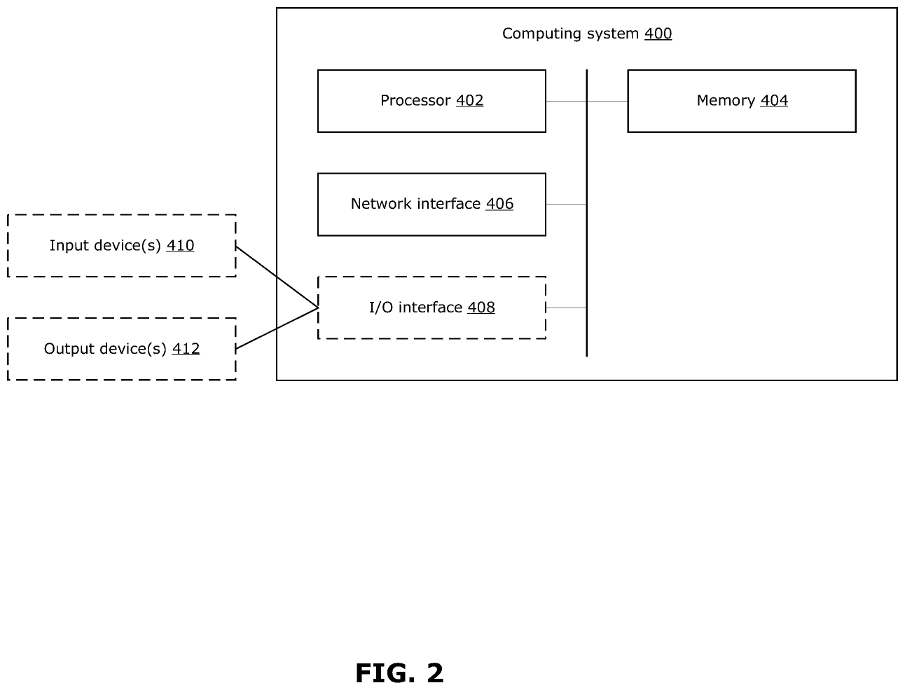

The software platform 200 may be implemented using one or more computing systems, such as one or more servers. For example, the software platform 200 may be implemented using a computing system 400 as shown in FIG. 2.

The example computing system 400 includes at least one processor 402 and at least one memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to enable the software platform 200, which is implemented by the computing system 400, to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the software platform 200 to carry out communications (e.g., wireless communications) with the user device 150 and/or the third-party service provider 280.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

As previously mentioned, the package tracking engine 250 performs operations to enable a user to view tracking information 284 associated with a third-party account 282 that has been linked to the user account 220. A user may manually link a third-party account 282 with the user account 220 (e.g., the user may provide user input, via the user device 150, to identify the third-party account 282 to be linked). However, the user may find it difficult or tedious to manually link the third-party account 282, particularly if the user is using a user device 150 having limited input/output capabilities (e.g., a handheld device having a small display screen and/or having limited input mechanisms). In some cases, the user may only know the package tracking identifier without knowing the identity of the third-party service provider 280, and thus the user may not have sufficient information to link a third-party account 282.

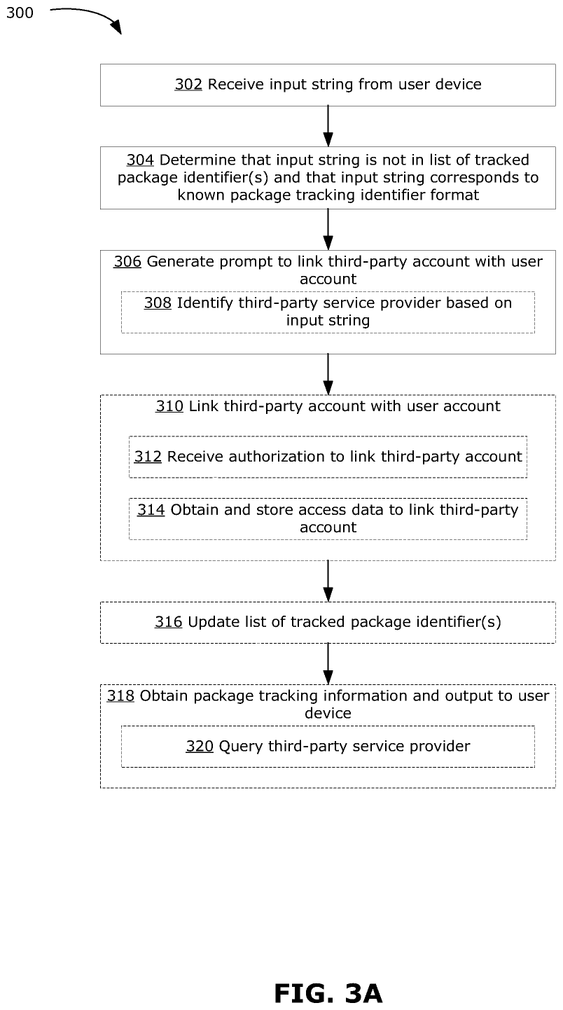

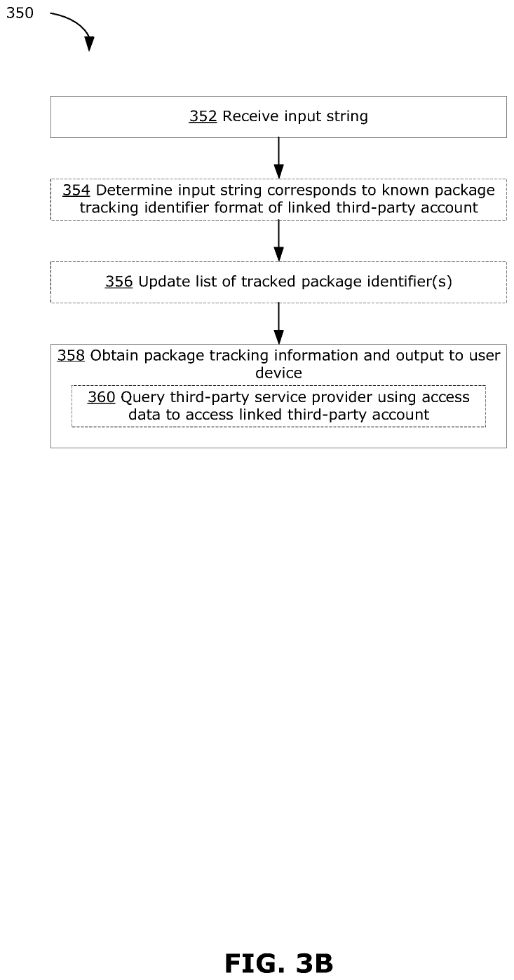

FIG. 3A is a flowchart illustrating an example method 300 that may be performed by the software platform 200, for example using the package tracking engine 250, to automatically prompt a user to link a third-party account 282 with a user account 220, based on an input string that corresponds to a package tracking identifier.

For example, the method 300 may be performed if the package tracking identifier is not found in the list of tracked package tracking identifier(s) 222 associated with the user account 220 and/or if the package tracking identifier is not found in any third-party accounts 282 already linked with the user account 220.

At an operation 302, an input string is received from the user device 150 that is associated with a user account 220 maintained on the software platform 200. The input string may be a text string including alphanumeric characters, for example.

The input string may be provided in the form of a search query to the search engine 210 (e.g., inputted into a search field on a search page) or may be provided as input to the package tracking engine 250 (e.g., inputted into a tracking identifier field on a package tracking page), for example. If the input string is provided to the search engine 210, the search engine 210 may, in addition to searching the data 260 and/or external data 270 based on the input string, provide the input string to the package tracking engine 250 (or in other words, the search engine 210 may use the package tracking engine 250 to help carry out a search using the input string).

At an operation 304, it is determined that the list of tracked package identifier(s) 222 associated with the user account 220 does not already include a package tracking identifier matching the input string. In some examples, package tracking identifiers may be automatically extracted from all third-party accounts 282 that are linked to the user account 220 and automatically added to the list of tracked package identifier(s) 222. Thus, it may be assumed that if the input string does not match a package tracking identifier in the list of tracked package identifier(s) 222 then this means that the input string corresponds to a package tracking identifier associated with a third-party account 282 that has not yet been linked to the user account 220. In other examples, if the list of tracked package identifier(s) 222 does not already include a package tracking identifier matching the input string, the package tracking engine 250 may attempt to find a package tracking identifier matching the input string in the already-linked third-party accounts 282 (e.g., as identified in the list of linked third-party account(s) 224). If there is no package tracking identifier matching the input string in the already-linked third-party accounts 282, then it may be determined that the input string corresponds to a package tracking identifier associated with a third-party account 282 that has not yet been linked to the user account 220.

At the operation 304, it is also determined that the input string corresponds to a known package tracking identifier format. The package tracking engine 250 may store information about how certain third-party service providers 280 format their package tracking identifiers. A third-party service provider 280 may be known to use package tracking identifiers having a specific number of digits or a specific combination of alphabetic and numeric characters. For example, a package tracking identifier that starts with the alphanumeric characters “1Z” may correspond to a known package tracking identifier format for the third-party service provider United Parcel Service (UPS).

At an operation 306, responsive to the determination at the operation 304, a prompt is generated to link a third-party account 282 with the user account 220. The prompt may be outputted via the user device 150.

The prompt may, for example, enable the user to identify a third-party service provider 280 using a drop-down menu. The prompt may display common third-party service providers 280 (e.g., carriers commonly used in the user's geographic area) and/or may be limited to third-party service providers 280 that are not already associated with a linked account in the list of linked third-party account(s) 224.

Optionally, at an operation 308, the package tracking engine 250 may automatically identify the appropriate third-party service provider 280 based on the input string. For example, the package tracking engine 250 may automatically determine that the input string corresponds to the package tracking identifier format associated with a particular third-party service provider 280. The generated prompt may thus prompt the user to link to a third-party account 282 associated with that particular third-party service provider 280. This may help to simplify and/or reduce the user interactions required to link a third-party account 282 with the user account 220.

Optionally, at an operation 310, a particular third-party account 282 may be linked with the user account 220. The operation 310 may be performed using operations 312 and 314, for example.

The prompt generated at the operation 306 may include a request for user authorization to link the particular third-party account 282 with the user account 220. Optionally, at the operation 312, an indication of authorization may be received, from the user device 150, to link the particular third-party account 282 with the user account 220. For example, the indication of authorization may include a username and password associated with the particular third-party account 282.

At the operation 314, access data is obtained for linking the particular third-party account 282 with the user account 220. The access data may, for example be an access token (e.g., an access token in accordance with the OAuth 2.0 authorization protocol), a digital certificate, a digital key, or a username and password pair. The obtained access data may be stored in the access data store 254 of the package tracking engine 250, for example. In other examples, the access data may be stored in association with the user account 220.

Optionally, at an operation 316, the list of tracked package identifier(s) 222 associated with the user account 220 may be updated to include the package tracking identifier corresponding to the input string.

Optionally, at an operation 318, package tracking information is obtained from the third-party account 282 that has been linked (at the operation 310) and the package tracking information is outputted to the user via the user device 150. The access data (obtained at the operation 314) may be used to access the linked third-party account 282, in order to obtain the package tracking information. For example, the access data may be provided to the third-party service provider 280 to authorize the software platform 200 to obtain package tracking information associated with the linked third-party account 282. Thus, at an operation 320, package tracking information may be obtained from the linked third-party account 282 by providing the input string as a query to the third-party service provider 280.

In some examples, a third-party service provider 280 may require additional information in order to provide tracking information to the software platform 200. For example, the third-party service provider 280 may require a user's personal information (e.g., home address, legal name, etc.) in addition to the access data before the software platform 200 is authorized to obtain the tracking information. The software platform 200 may automatically extract the required additional information from a user profile associated with the user account 220, and may provide the additional information to the third-party service provider 280 without requiring any user input. For example, the user may provide consent to permit the software platform 200 to access the user's personal information and to share the user's personal information with a third-party service provider 280 after the third-party account has been linked.

In some examples, the package tracking engine 250 may extract all tracking information associated with all package tracking identifiers found for the linked third-party account 282, and then identify which of the extracted tracking information is the tracking information for the particular package tracking identifier corresponding to the input string.

The package tracking information may be outputted to the user device 150 in various ways. For example, if the input string was received as a search query (e.g., as input to a search field on a search page), the package tracking information may be outputted as a search result that is included in the list of search results returned by the search engine 210. In another example, a portion of the package tracking information may be outputted ahead of or below a display of the input string on the user device as part of, for example, a typeahead or autocomplete feature. In another example, the package tracking information that is associated with the particular package tracking identifier corresponding to the input string may be outputted in a list that includes tracking information associated with other package tracking identifiers (e.g., other package tracking identifiers that are included in the list of tracked package identifier(s) 222).

After the third-party account 282 has been linked with the user account 220 (e.g., using the method 300), the package tracking engine 250 may extract tracking information from the linked third-party account 282 in response to further queries from the user device 150 and/or absent further communications from the user device 150.

FIG. 3B is a flowchart illustrating an example method 350 that may be performed by the software platform 200, for example using the package tracking engine 250, to provide a user with package tracking information from a third-party account 282 that has been linked with a user account 220.

For example, the method 350 may be performed after performing the method 300 to link the third-party account 282 with the user account 220. In other examples, the method 350 may be performed after the third-party account 282 has been linked in other ways.

At an operation 352, an input string is received from the user device 150 that is associated with a user account 220 maintained on the software platform 200. The operation 352 may be similar to the operation 302 described above.

At an optional operation 354, it may be determined that the input string corresponds to a known package tracking identifier format that is associated with a particular linked third-party account. For example, the package tracking engine 250 may compare the input string to the known package tracking identifier formats used by different third-party service providers 280. Then, after finding that the input string has a format that matches the known package tracking identifier format of a particular third-party service provider 280, the package tracking engine 250 may check the list of linked third-party account(s) 224 to determine that the list of linked third-party account(s) 224 includes a linked third-party account corresponding to the particular third-party service provider 280.

At an optional operation 356, if the input string does not match any package tracking identifier in the list of tracked package identifier(s) 222, the package tracking engine 250 may update the list of tracked package identifier(s) 222 to include a package tracking identifier corresponding to the input string.

Since there is already a linked third-party account 282 corresponding to the particular third-party service provider 280, there is no need to prompt the user to link the third-party account. Further, this means that the package tracking engine 250 already has access data stored in the access data store 254 that authorizes the package tracking engine 250 to access and obtain information from the linked third-party account 282, without requiring further user input.

In some examples, instead of performing operations 354 and 356 following receipt of the input string (at the operation 352), the package tracking engine 250 may automatically, without requiring any input from the user, obtain information from all linked third-party accounts 282 (e.g., as indicated in the list of linked third-party account(s) 224) using access data stored in the access store 254 at intervals. The information that is obtained may include tracking information associated with package tracking identifiers included in the list of tracked package identifier(s) 222, as well as any new package tracking identifiers that are not already in the list of tracked package identifier(s) 222. If the package tracking engine 250 obtains from a linked third-party account 282 a new package tracking identifier that is not already in the list of tracked package identifier(s) 222, the list of tracked package identifier(s) 222 may be updated to include the new package tracking identifier.

The package tracking engine 250 may automatically obtain information from a linked third-party account 282 by, for example, using the corresponding access data to verify to the third-party service provider 280 that the package tracking engine 250 has authorization to access information from the linked third-party account 282, then querying the third-party service provider 280 for all tracking information 284 related to the linked third-party account 282. The information may be obtained from linked third-party accounts 282 regularly (e.g., such as daily), for example as part of regular maintenance to the user account 220.

Thus, the list of tracked package identifier(s) 222 may already be updated to include the package tracking identifier corresponding to the received input string, without performing operations 354 and 356 following receipt of the input strong.

At an operation 358, package tracking information associated with the particular package tracking identifier corresponding to the input string is obtained from the linked third-party account 282. Optionally, the operation 358 may be carried out using an operation 360.

At the optional operation 360, the particular third-party service provider 280 may be queried by the package tracking engine 250. The package tracking engine 250 may use access data from the access data store 254 to access the particular linked third-party account 282, in order to obtain the package tracking information.

Alternatively, instead of performing the operation 360, the tracking information associated with the particular package tracking identifier may have been obtained from the linked third-party account 282 prior to receipt of the input strong, as noted above. In such examples, obtaining the package tracking information may involve retrieving the package tracking information that is stored with the corresponding package tracking identifier in the list of tracked package identifier(s) 222.

The package tracking information associated with the package tracking identifier corresponding to the input string may then be outputted to the user device 150.

It may be noted that, using the method 350, the package tracking information may be outputted to the user without requiring any user interactions other than input of the input string 352. Thus, the communications between the user device 150 and the software platform 200 may be limited to communication of the input string and communication of the package tracking information. Not only does this greatly simplify the user interactions, enabling a more efficient user interface, this also greatly reduces the amount of communications required between the user device 150 and the software platform 200, thus making more efficient use of computing resources and communication bandwidth.

Further, as described above, in some examples the package tracking engine 250 may automatically and without any communication with the user device 150 obtain information from third-party accounts 282 that are linked with the user account 220. Thus, the tracking information may be obtained from linked third-party accounts 282 ahead of any query or input from the user device 150, and simply displayed via the user device 150 when requested. This may help to reduce the time required to provide the user with requested tracking information, particularly because the speed of response to the user would not be dependent on the speed of the third-party service provider 280 (which is outside the control of the software platform 200). Further, the package tracking engine 250 may schedule queries to third-party service providers 280 at a time when computing resources (e.g., communication bandwidth, processor power, etc.) are expected to be in lower demand.

In some examples, the software platform 200 may communicate with the user device 150 via a software application executed on the user device 150. For example, the user may log onto their user account 220 by entering credentials (e.g., username and password) into login page of the software application on the user device 150, and may access services provided by the software platform 200 via the software application on the user device 150. In this way, the user device 150 may act as a thin client to enable the user to access services provided by the software platform 200, including the package tracking service disclosed herein.

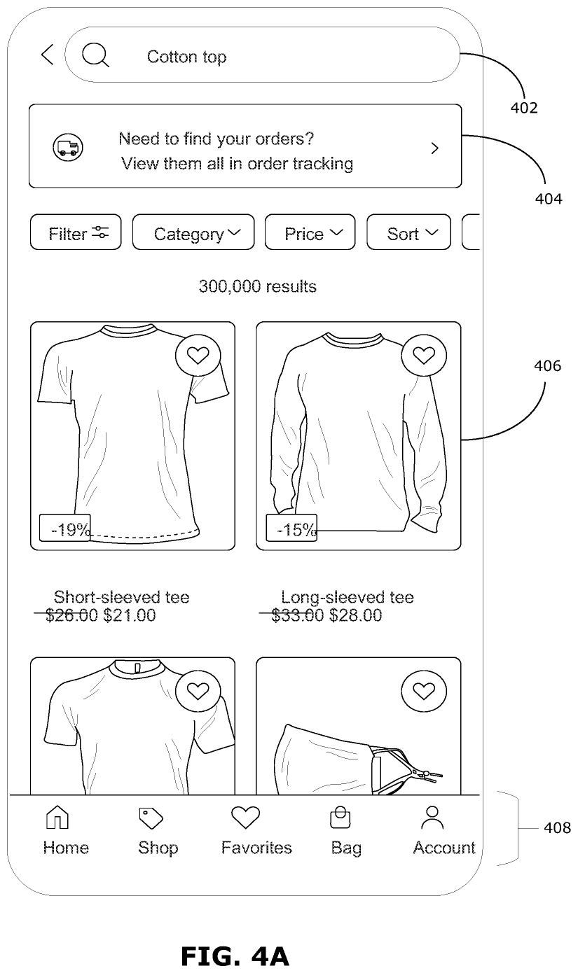

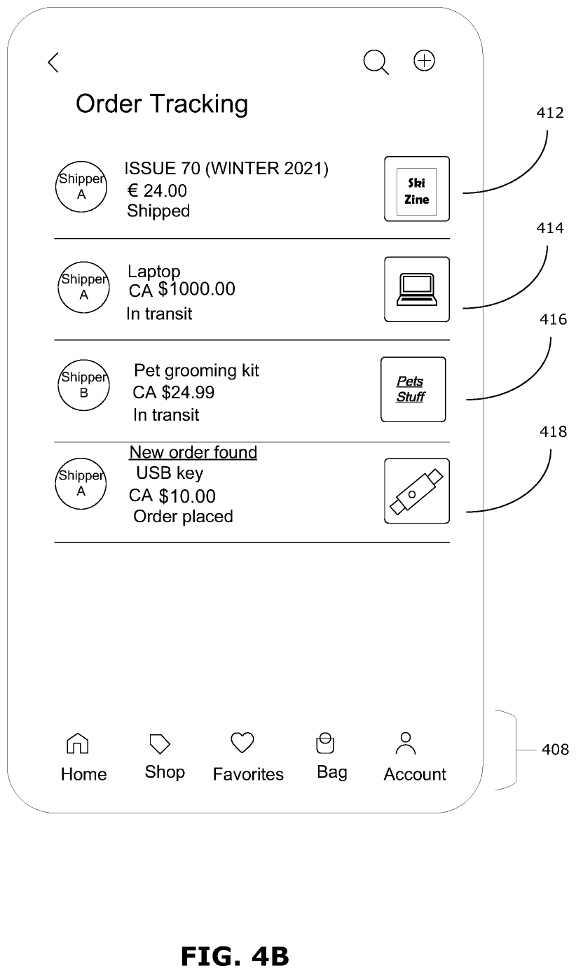

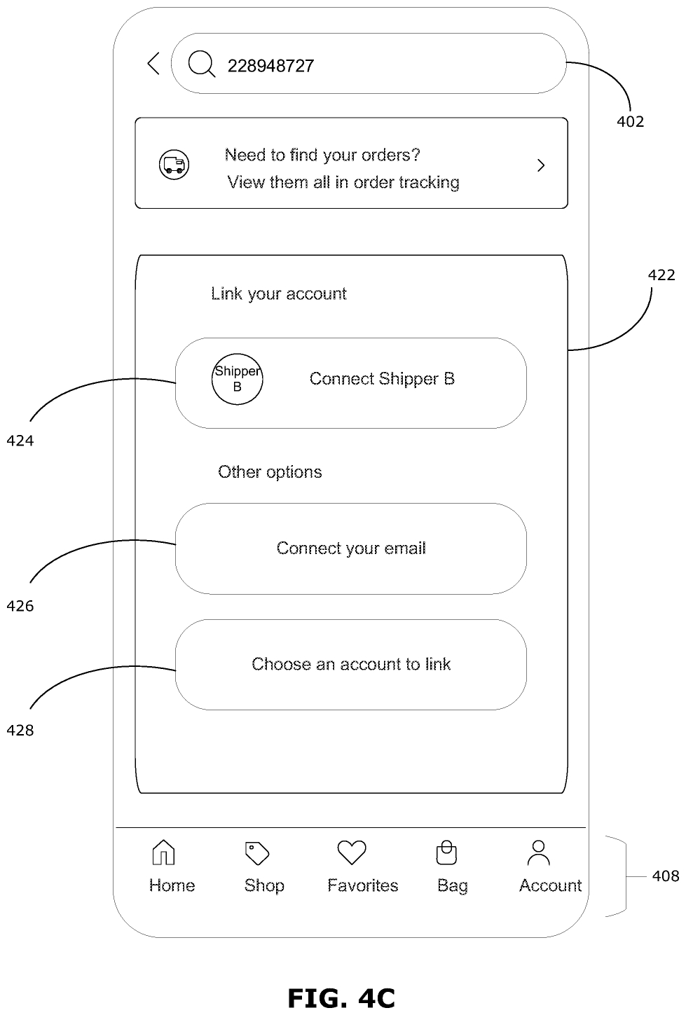

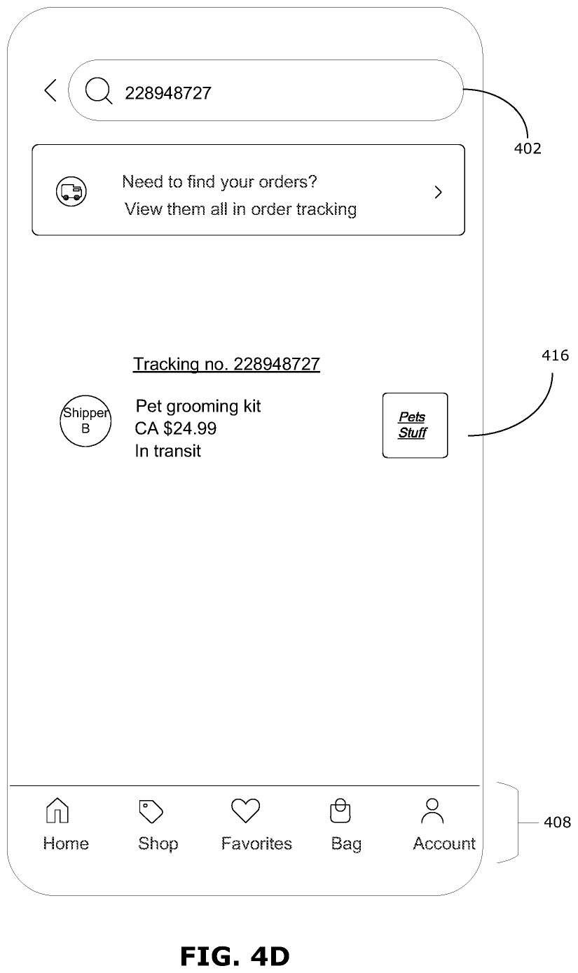

FIGS. 4A-4D illustrate example user interfaces (UIs), which may be presented to the user via the user device 150, for interacting with the software platform 200. FIGS. 4A-4D illustrate examples in the context of the user device 150 being a smartphone, however it should be understood that this is not intended to be limiting.

FIG. 4A illustrates an example UI that may be presented to a user, via the user device 150, to enable the user to conduct online searches using the software platform 200 (e.g., using the search engine 210).

The UI in this example includes a search field 402, which may receive an input string in the form of a search query. In this example, the input string is a search query for a product (“Cotton top”) and the search engine 210 has returned search results 406 based on the input string. The UI also includes an order tracking option 404, which may be selected to enable information about tracked packages (which may be stored in the list of tracked package identifier(s) 222) to be presented to the user. The UI may include additional selectable elements 408, which may enable the user to access other services provided by the software platform 200, such as navigation to a home page, access to online shopping, display of saved favorite pages, access to a virtual shopping bag, and user account management.

FIG. 4B illustrates an example UI that may be presented to the user after the order tracking option 404 has been selected. In this UI, tracking information 412, 414, 416, 418 associated with tracked package identifiers are displayed. The tracking information 412, 414, 416, 418 may be displayed with an indication of the third-party service provider that is responsible for delivery (e.g., Shipper A or Shipper B), a description of the package content, a cost of the product, an image of the package content (or a logo of the associated retailer), and a package status (e.g., shipped, in transit, order placed, etc.). In this example, the UI includes tracking information 418 associated with a package identifier that was found from a linked third-party account (i.e., not explicitly inputted by a user). For example, the package tracking engine 250 may have access the linked third-party account 282 associated with the third-party service provider 280 Shipper A using stored access data, and extracted a new package tracking identifier together with associated tracking information. The list of tracked package identifier(s) 222 may be updated with this information, so that when the user views the order tracking UI this new information is included (e.g., as shown in FIG. 4B). The tracking information 418 may be indicated as “new order found”, to alert the user to the new order tracking information. The UI may also include additional selectable elements 408, as described above.

FIG. 4C illustrates another instance of an example UI for conducting an online search. In this example, the input string in the search field 402 corresponds to a package tracking identifier. The search engine 210 may recognize that the input string is likely to be a package tracking identifier, for example because the input string does not match any English language words. The search engine 210 may thus provide the input string to be processed by the package tracking engine 250. The package tracking engine 250 may determine that the input string does not correspond to any package tracking identifier in the list of tracked package identifier(s) 222 and may, using the method 300 for example, generate a prompt 422 for the user to link a third-party account 282 to the user's user account 220.

In this example, the prompt 422 includes an option 424 to link to a third-party account associated with a particular third-party service provider “Shipper B”. For example, the input string may match the known package tracking identifier format that is associated with Shipper B and thus the package tracking engine 250 may automatically determine that the user should be prompted to link a third-party account associated with Shipper B. The prompt 422 may optionally include other options, such as an option 426 to link a third-party email account and an option 428 to link some other third-party account. The prompt 422 may also include an option to reject linking a third-party account (not shown) or an option to dismiss the prompt 422 without any linking.

In this example, the user may select the option 424 to link the third-party account associated with Shipper B. The user may additionally provide authorization information (e.g., username and password) to enable access data (e.g., an access token) to be obtained from Shipper B, which may be stored in the access data store 254. Using the access data, the package tracking engine 250 may extract tracking information associated with the package tracking identifier corresponding to the input string.

As shown in FIG. 4D, the extracted tracking information 416 may be presented as a search result that is viewable via the UI for conducting online searches. The package tracking identifier may also be included in the list of tracked package identifier(s) 222.

In some examples, the software platform 200 may be an e-commerce platform. An example of an e-commerce platform is described below. However, it should be understood that this discussion is only for the purpose of illustration and is not intended to be limiting as to the nature of an e-commerce system or software platform with which the subject matter of the present application may be implemented. Further, it should be understood that the present disclosure may be implemented in other contexts, and is not necessarily limited to implementation in an e-commerce platform. For example, the present disclosure may be implemented in the context of any other software platform that provides services to a user, without necessarily supporting any e-commerce. Other such possibilities are contemplated within the scope of the present disclosure.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

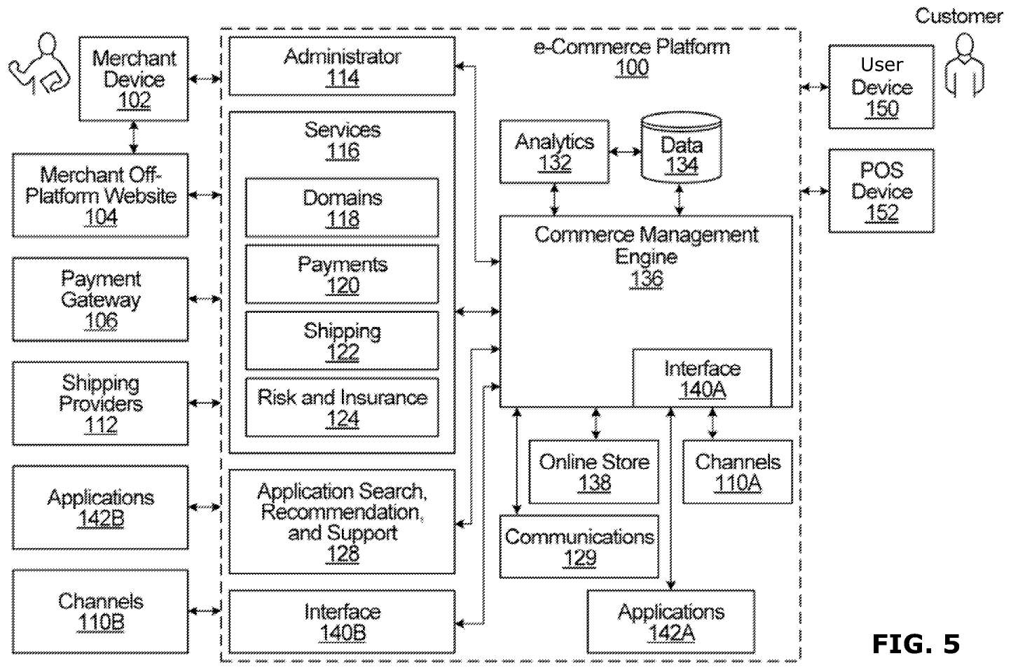

FIG. 5 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 2, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

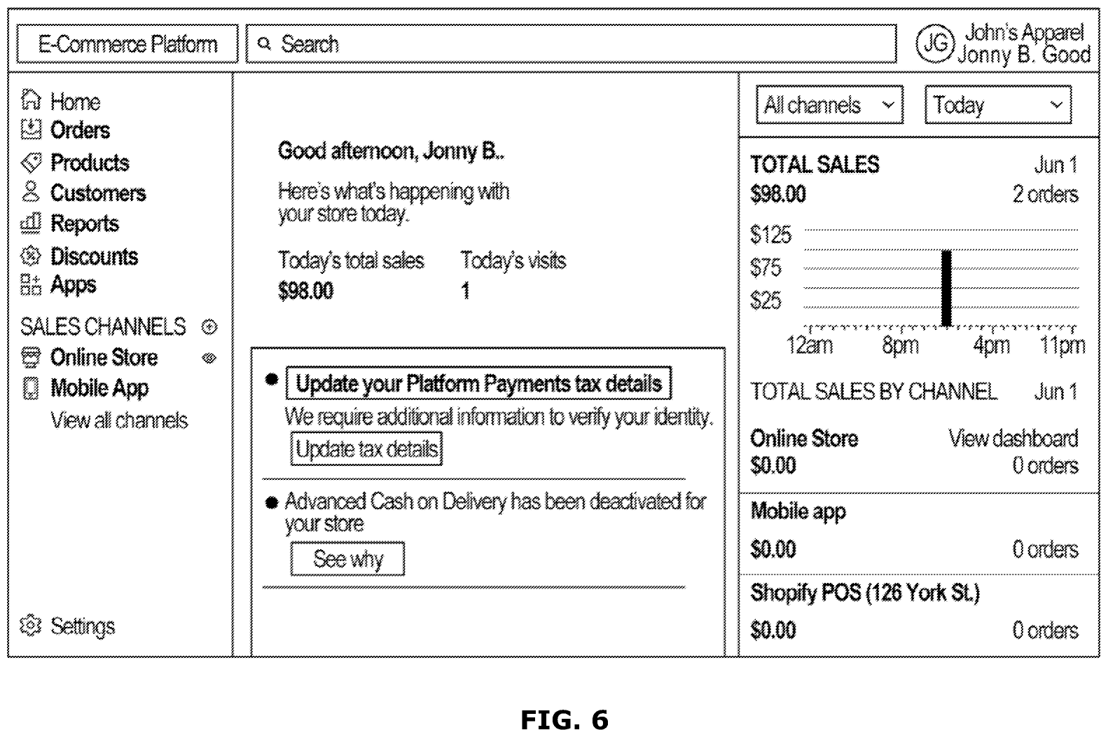

FIG. 6 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalogue, managing orders, and/or the like. In some embodiments, the merchant may be able to access the different sections of the administrator 114 by using a sidebar, such as the one shown on FIG. 3. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 2, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales) (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

Implementation on an e-Commerce Platform

Having discussed an example e-commerce platform, package tracking and linking of third-party accounts, as disclosed herein, as may be implemented as part of the services provided by the e-commerce platform. In some implementations, the functionality described herein may be used in commerce to provide improved customer experiences and to enable more efficient use of resources by the e-commerce platform.

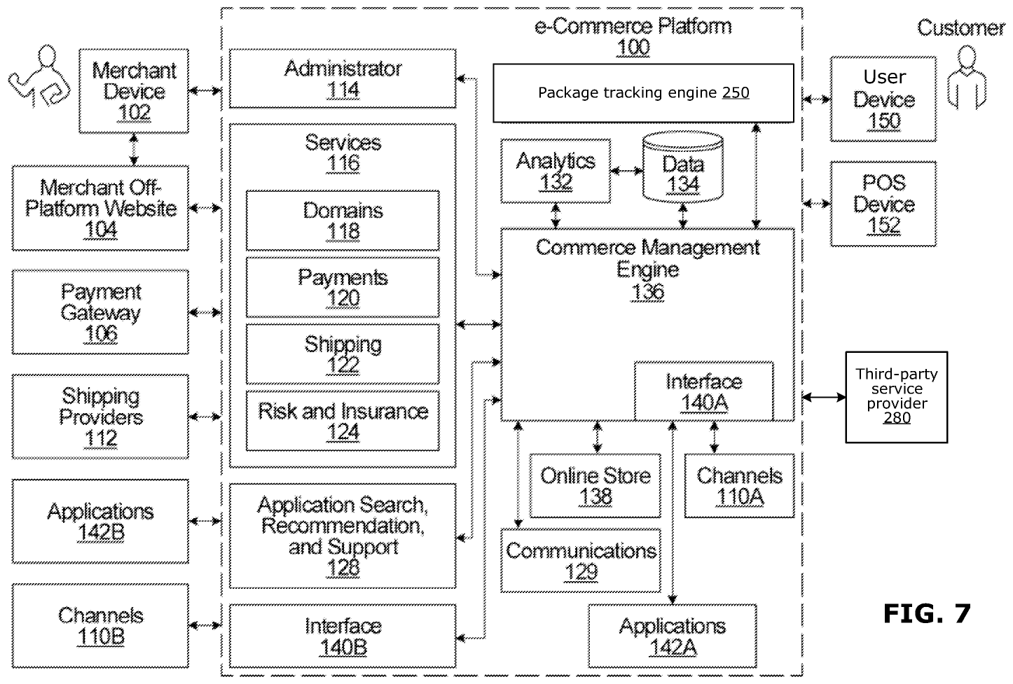

For example, FIG. 7 illustrates the e-commerce platform 100 of FIG. 5, but including the package tracking engine 250. Thus, the e-commerce platform 100 may, using the package tracking engine 250, perform any of the methods disclosed herein.

Although the package tracking engine 250 is illustrated as a distinct component of the e-commerce platform 100 in FIG. 7, this is only an example. The package tracking engine 250 could also or instead be provided by another component residing within or external to the e-commerce platform 100. In some embodiments, either or both of the applications 142A-B may provide an embodiment of the package tracking engine 250 that implement the functionalities described herein. The location of the package tracking engine 250 may be implementation specific.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
receiving, from a user device associated with a user account, an input string;
determining that the input string corresponds to one or more known identifier formats and that a list of one or more known identifiers associated with the user account does not include an identifier matching the input string; and
responsive to determining that the list of one or more known identifiers associated with the user account does not include an identifier matching the input string, generating a prompt, for output by the user device, to link a third-party account with the user account.

2. The method of claim 1, wherein the one or more known identifier formats are known package tracking identifier formats and wherein the user account does not include a package tracking identifier matching to input string.

3. The computer-implemented method of claim 2, further comprising:
identifying a third-party service provider based on the input string;
wherein the generated prompt is to link a third-party account associated with the identified third-party service provider.

4. The computer-implemented method of claim 3, wherein the identified third-party service provider is identified based on the input string corresponding to a particular known package tracking identifier format associated with the identified third-party service provider.

5. The computer-implemented method of claim 2, further comprising:
responsive to receiving, from the user device, an indication of authorization to link a particular third-party account with the user account, obtaining and storing access data for linking the particular third-party account with the user account.

6. The computer-implemented method of claim 5, further comprising:
updating the list of one or more tracked package identifiers associated with the user account to include a particular package tracking identifier corresponding to the input string; and
outputting, via the user device, package tracking information associated with the particular package tracking identifier, the package tracking information being obtained from the linked particular third-party account.

7. The computer-implemented method of claim 6, wherein the package tracking information is obtained from the linked particular third-party account by providing the particular package tracking identifier as a query to a third-party service provider associated with the particular third-party account.

8. The computer-implemented method of claim 6, further comprising:
receiving, from the user device, a further input string;
determining that the further input string corresponds to a particular known package tracking identifier format associated with the linked particular third-party account and that the list of one or more tracked package identifiers associated with the user account does not include a package tracking identifier matching the further input string;
absent further communication with the user device:
obtaining, from the linked particular third-party account, further package tracking information associated with a further package tracking identifier corresponding to the further input string;
updating the list of one or more tracked package identifiers associated with the user account to include the further package tracking identifier; and
outputting, via the user device, the further package tracking information.

9. The computer-implemented method of claim 6, further comprising:
absent further communication with the user device:
extracting, from the linked particular third-party account, a new package tracking identifier, the new package tracking identifier being absent from the list of one or more tracked package identifiers associated with the user account; and
updating the list of one or more tracked package identifiers associated with the user account to include the new package tracking identifier.

10. The computer-implemented method of claim 9, further comprising:
responsive to receiving, from the user device, a new input string corresponding to the new package tracking identifier, outputting, via the user device, new package tracking information associated with the new package tracking identifier, the new package tracking information being obtained from the linked particular third-party account.

11. The computer-implemented method of claim 1, further comprising:
identifying a third-party service provider that is not associated with any third-party account currently linked with the user account;
wherein the generated prompt is to link a third-party account associated with the identified third-party service provider.

12. A computing system comprising:
a processor configured to execute instructions to cause the system to:
receive, from a user device associated with a user account, an input string;
determine that the input string corresponds to one or more known package tracking identifier formats and that a list of one or more tracked package identifiers associated with the user account does not include a package tracking identifier matching the input string; and
responsive to determining that the list of one or more tracked package identifiers associated with the user account does not include a package tracking identifier matching the input string, generate a prompt, for output by the user device, to link a third-party account with the user account.

13. The computing system of claim 12, wherein the processor is further configured to execute the instructions to cause the system to:
identify a third-party service provider based on the input string;
wherein the generated prompt is to link a third-party account associated with the identified third-party service provider.

14. The computing system of claim 13, wherein the identified third-party service provider is identified based on the input string corresponding to a particular known package tracking identifier format associated with the identified third-party service provider.

15. The computing system of claim 12, wherein the processor is further configured to execute the instructions to cause the system to:
responsive to receiving, from the user device, an indication of authorization to link a particular third-party account with the user account, obtain and store access data for linking the particular third-party account with the user account.

16. The computing system of claim 15, wherein the processor is further configured to execute the instructions to cause the system to:
update the list of one or more tracked package identifiers associated with the user account to include a particular package tracking identifier corresponding to the input string; and
output, via the user device, package tracking information associated with the particular package tracking identifier, the package tracking information being obtained from the linked particular third-party account.

17. The computing system of claim 16, wherein the processor is further configured to execute the instructions to cause the system to:
receive, from the user device, a further input string;
determine that the further input string corresponds to a particular known package tracking identifier format associated with the linked particular third-party account and that the list of one or more tracked package identifiers associated with the user account does not include a package tracking identifier matching the further input string;
absent further communication with the user device:
obtain, from the linked particular third-party account, further package tracking information associated with a further package tracking identifier corresponding to the further input string;
update the list of one or more tracked package identifiers associated with the user account to include the further package tracking identifier; and
output, via the user device, the further package tracking information.

18. The computing system of claim 16, wherein the processor is further configured to execute the instructions to cause the system to:
absent further communication with the user device:
extract, from the linked particular third-party account, a new package tracking identifier, the new package tracking identifier being absent from the list of one or more tracked package identifiers associated with the user account; and
update the list of one or more tracked package identifiers associated with the user account to include the new package tracking identifier.

19. The computing system of claim 18, wherein the processor is further configured to execute the instructions to cause the system to:
responsive to receiving, from the user device, a new input string corresponding to the new package tracking identifier, output, via the user device, new package tracking information associated with the new package tracking identifier, the new package tracking information being obtained from the linked particular third-party account.

20. The computing system of claim 12, wherein the processor is further configured to execute the instructions to cause the system to:
identify a third-party service provider that is not associated with any third-party account currently linked with the user account;
wherein the generated prompt is to link a third-party account associated with the identified third-party service provider.

21. A computer-readable medium storing instructions that, when executed by a processor of a computing system, cause the computing system to:
receive, from a user device associated with a user account, an input string;
determine that the input string corresponds to one or more known package tracking identifier formats and that a list of one or more tracked package identifiers associated with the user account does not include a package tracking identifier matching the input string; and
responsive to determining that the list of one or more tracked package identifiers associated with the user account does not include a package tracking identifier matching the input string, generate a prompt, for output by the user device, to link a third-party account with the user account.
